(19) United States
(12) Patent Application Publication
(10) Pub. No.: US 2025/0227211 A1
(43) Pub. Date: Jul. 10, 2025

(54) DISPLAY CONTROL METHOD, DISPLAY DEVICE, AND NON-TRANSITORY COMPUTER-READABLE STORAGE MEDIUM STORING DISPLAY CONTROL PROGRAM

(71) Applicant: SEIKO EPSON CORPORATION, Tokyo (JP)

(72) Inventors: Kyosuke ITAHANA, Matsumoto-shi (JP); Akihiko YAMAMOTO, Yamagata-mura (JP)

(73) Assignee: SEIKO EPSON CORPORATION, Tokyo (JP)

(21) Appl. No.: 19/013,098

(22) Filed: Jan. 8, 2025

(30) Foreign Application Priority Data
Jan. 9, 2024 (JP) 2024-001097

(51) Int. Cl. H04N 9/31

(52) U.S. Cl. CPC H04N 9/3188

(57) ABSTRACT

A display control method includes causing a projector to display a first image formed by picking up an image of a state where a first projector is projecting a first projection image corresponding to a first content, onto a projection surface, and a second image that is a plurality of thumbnail images respectively indicating a plurality of contents corresponding to a projection image that a second projector can project.

The present application is based on, and claims priority from JP Application Serial Number 2024-001097, filed Jan. 9, 2024, the disclosure of which is hereby incorporated by reference herein in its entirety.

### BACKGROUND

### 1. Technical Field

The present disclosure relates to a display control method, a display device, and a non-transitory computer-readable storage medium storing a display control program.

### 2. Related Art

For example, JP-A-2018-85754 discloses an electronic device that, based on information about a content list provided by a server, reproduces a highlight video of a moving image included in the content list and thus provides a preview of the moving image.

JP-A-2018-85754 is an example of the related art.

In the technique described in JP-A-2018-85754, since a preview of a moving image is simply displayed, it is difficult for a user to grasp and imagine a method of utilizing a content using a projector.

### SUMMARY

According to an aspect of the present disclosure, a display control method includes causing a display device to display a first image showing a state where a first projector is projecting a first projection image corresponding to a first content, onto a projection surface, and a second image that is a plurality of thumbnail images respectively indicating a plurality of contents corresponding to a projection image that a second projector can project.

According to another aspect of the present disclosure, a display device displays a first image showing a state where a first projector is projecting a first projection image corresponding to a first content, onto a projection surface, and a second image that is a plurality of thumbnail images respectively indicating a plurality of contents corresponding to a projection image that a second projector can project.

According to still another aspect of the present disclosure, a non-transitory computer-readable storage medium storing a display control program is provided, the display control program causing a computer controlling a display device, to execute causing the display device to display a first image showing a state where a first projector is projecting a first projection image corresponding to a first content, onto a projection surface, and a second image that is a plurality of thumbnail images respectively indicating a plurality of contents corresponding to a projection image that a second projector can project.

### BRIEF DESCRIPTION OF THE DRAWINGS

FIG. 1 shows an example of the configuration of a projector according to an embodiment.

FIG. 2 shows an example of the configuration of a first controller of the projector.

FIG. 3 shows a first projection image including a first image, a second image, and a third image.

FIG. 4 shows a second projection image including a first image, a second image, and a third image.

FIG. 5 shows a third projection image including a first image, a second image, and a third image.

FIG. 6 shows a fourth projection image including a first image, a second image, and a third image.

FIG. 7 shows a fifth projection image including a first image, a second image, and a third image.

FIG. 8 is a flowchart illustrating an example of processing of the first controller.

### DESCRIPTION OF EMBODIMENTS

An embodiment will now be described with reference to the drawings.

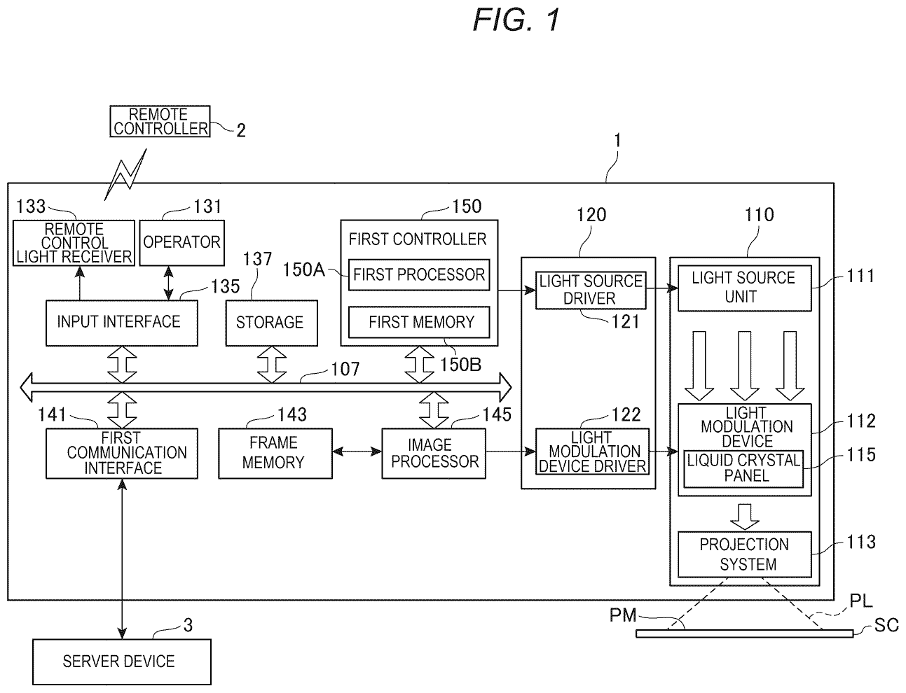

First, the configuration of a projector 1 according to the present embodiment will be described with reference to FIG. 1. FIG. 1 shows an example of the configuration of the projector 1 according to the present embodiment.

As illustrated in FIG. 1, the projector 1 includes a projection unit 110 and a driver 120 that drives the projection unit 110. The projection unit 110 forms an optical image and projects an image light PL onto a screen SC. In the present embodiment, the projection unit 110 projects the image light PL corresponding to a projection image PM onto the screen SC.

The projection unit 110 includes a light source unit 111, a light modulation device 112, and a projection system 113. The driver 120 includes a light source driver 121 and a light modulation device driver 122.

The projector 1 corresponds to an example of a “display device”.

The projector 1 also corresponds to an example of a “second projector”.

A second projector PJ2 may be the same projector as a “first projector” or may be a different projector from the “first projector”.

In the present embodiment, a case where the second projector PJ2 is a projector PJ that is different from a first projector PJ1 is described. The first projector PJ1 is, for example, a projector PJ owned by a management company that manages a server device 3. The second projector PJ2 is the projector 1 owned by the user.

The light source unit 111 includes a light source 111A. The light source 111A is, for example, a solid-state light source such as a light-emitting diode (LED) or a laser light source.

In the present embodiment, a case where the light source 111A of the light source unit 111 is a solid-state light source is described, but this is not limiting. The light source 111A of the light source unit 111 may be a lamp light source such as a halogen lamp, a xenon lamp, or an ultra-high-pressure mercury lamp.

The light source unit 111 may include a reflector and an auxiliary reflector that guide light emitted from the light source 111A to the light modulation device 112. The light source unit 111 may also include a lens group for improving an optical characteristic of projected light, a polarizing plate, or a dimming element for reducing the amount of light of the light emitted from the light source, on a path leading to the light modulation device 112, or the like.

The light source driver 121 is coupled to an internal bus 107, turns on and off the light source 111A of the light source unit 111 according to an instruction from a first controller 150 similarly coupled to the internal bus 107, and thus controls the output of the light source.

The light modulation device 112 includes, for example, three liquid crystal panels 115 corresponding to the three primary colors of R, G, and B. R represents red, G represents green, and B represents blue. That is, the light modulation device 112 includes the liquid crystal panel 115 corresponding to R color light, the liquid crystal panel 115 corresponding to G color light, and the liquid crystal panel 115 corresponding to B color light.

The light emitted from the light source unit 111 is separated into color lights of the three colors of RGB, which become incident on the corresponding liquid crystal panels 115, respectively. Each of the three liquid crystal panels 115 is a transmission-type liquid crystal panel and modulates transmitted light to generate a first image light. The first image lights transmitted through and modulated by the liquid crystal panels 115 are combined together by a combining system such as a cross dichroic prism and emitted to the projection system 113.

In the present embodiment, a case where the light modulation device 112 includes the transmission-type liquid crystal panels 115 as light modulation elements is described, but this is not limiting. The light modulation element may be a reflection-type liquid crystal panel or a digital micromirror device.

The light modulation device 112 is driven by the light modulation device driver 122. The light modulation device driver 122 is coupled to an image processor 145.

Image data corresponding to the primary colors of R, G, and B are input to the light modulation device driver 122 from the image processor 145. The light modulation device driver 122 converts the input image data into a data signal suitable for an operation of the liquid crystal panel 115. The light modulation device driver 122 applies a voltage to each pixel in each liquid crystal panel 115, based on the data signal obtained by the conversion, and draws an image on each liquid crystal panel 115.

The projection system 113 includes a projection lens, a mirror, and the like that cause the image light PL incident thereon to form an image on the screen SC. The projection system 113 also includes a zoom mechanism that enlarges or reduces the image projected on the screen SC, a focus adjustment mechanism that adjusts the focus, a lens shift mechanism that adjusts the direction of projection of the image light PL, and the like.

The projector 1 also includes an operator 131, a remote control light receiver 133, an input interface 135, a storage 137, a first communication interface 141, a frame memory 143, the image processor 145, and the first controller 150. The input interface 135, the storage 137, the first communication interface 141, the image processor 145, and the first controller 150 are coupled to one another via the internal bus 107 in such a way as to be able to communicate data.

The operator 131 includes various buttons and switches provided at a surface of the casing of the projector 1, generates an operation signal corresponding to an operation of the buttons and switches, and outputs the operation signal to the input interface 135. The input interface 135 includes a circuit that outputs the operation signal input from the operator 131 to the first controller 150.

The remote control light receiver 133 receives an infrared signal transmitted from a remote controller 2 and decodes the received infrared signal to generate an operation signal. The remote control light receiver 133 outputs the generated operation signal to the input interface 135. The input interface 135 includes a circuit that outputs the operation signal input from the remote control light receiver 133 to the first controller 150.

The storage 137 is, for example, a magnetic recording device such as a hard disk driver (HDD), or a storage device including a semiconductor storage element such as a flash memory or a solid-state drive (SSD). The storage 137 stores a program executed by the first controller 150, data processed by the first controller 150, image data, and the like. The storage 137 is an example of a non-transitory computer-readable storage medium. The storage medium may be a medium such as a compact disc read-only memory (CD-ROM) that is distributed to the user separately from the projector 1.

The first communication interface 141 is, for example, a communication interface that communicates with the server device 3 in conformity with the Ethernet (registered trademark) standard. The first communication interface 141 includes a connector that couples an Ethernet (registered trademark) cable, and an interface circuit that processes a signal transmitted through the connector. The first communication interface 141 is an interface board including the connector and the interface circuit and is coupled to a main board at which a first processor 150A of the first controller 150 and the like are installed. Alternatively, the connector and the interface circuit forming the first communication interface 141 are installed at the main board of the first controller 150. The first communication interface 141 receives image data and the like from the server device 3.

The first controller 150 includes a first memory 150B and the first processor 150A.

The first memory 150B is a storage device that stores a program executed by the first processor 150A and data in a nonvolatile manner. The first memory 150B is configured with a magnetic storage device, a semiconductor storage element such as a flash read-only memory (ROM), or a nonvolatile storage device of another type. The first memory 150B may also include a random-access memory (RAM) forming a work area of the first processor 150A. The first memory 150B stores data processed by the first controller 150, a first control program PG1 executed by the first processor 150A, and the like.

The first controller 150 controls the operation of each part of the projector 1.

The first processor 150A may be configured with a single processor, or a plurality of processors may function as the first processor 150A. The first processor 150A executes the first control program PG1 and thus controls each part of the projector 1. For example, the first processor 150A outputs an instruction to execute image processing corresponding to an operation received by the operator 131 and the remote controller 2 and a parameter used for the image processing to the image processor 145. The parameter includes, for example, a geometric correction parameter for correcting a geometric distortion of an image projected on the screen SC. The first processor 150A controls the light source driver 121 to turn on and off the light source unit 111 and adjusts the output of the light source unit 111, that is, the amount of light. The first processor 150A is an example of a computer that controls the projector 1 serving as a display device. The computer may be a personal computer coupled to the projector 1 and controlling the projector 1.

The first processor 150A may be configured with a system-on-a-chip (SoC) integrated with a part or all of the first memory 150B and other circuits. The first processor 150A may be configured with a combination of a central processing uni (CPU) that executes a program and a digital signal processor (DSP) that executes predetermined arithmetic processing. All of the functions of the first processor 150A may be implemented in hardware or may be configured using a programmable device.

The image processor 145 and the frame memory 143 can be configured, for example, with an integrated circuit. The integrated circuit includes a large-scale integration (LSI) circuit, an application-specific integrated circuit (ASIC), and a programmable logic device (PLD). The PLD includes, for example, a field-programmable gate array (FPGA). A part of the configuration of the integrated circuit may include an analog circuit, or a combination of a processor and the integrated circuit may be employed. The combination of the processor and the integrated circuit is called a microcontroller (MCU), a system-on-a-chip (SoC), a system LSI, a chip set, or the like.

The image processor 145 loads image data input from the first communication interface 141, into the frame memory 143. The frame memory 143 has a plurality of banks. Each bank has a storage capacity that enables writing of image data for one frame. The frame memory 143 is configured, for example, with a synchronous dynamic random-access memory (SDRAM).

The image processor 145 performs image processing such as resolution conversion processing, resize processing, distortion correction, shape correction processing, digital zoom processing, and adjustment of the color tone and luminance of the image, on the image data loaded in the frame memory 143.

The image processor 145 generates a vertical synchronization signal obtained by converting an input frame frequency of a vertical synchronization signal into a drawing frequency. The generated vertical synchronization signal is referred to as an output synchronization signal. The image processor 145 outputs the generated output synchronization signal to the light modulation device driver 122.

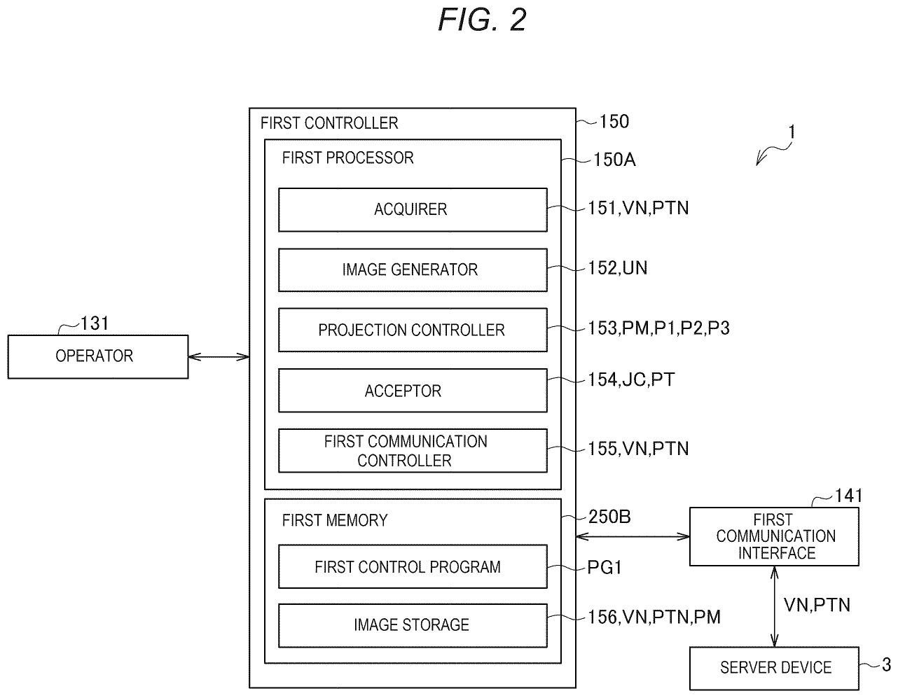

Next, the configuration of the first controller 150 of the projector 1 will be described with reference to FIG. 2. FIG. 2 shows an example of the configuration of the first controller 150 of the projector 1.

As illustrated in FIG. 2, the first controller 150 has an acquirer 151, an image generator 152, a projection controller 153, an acceptor 154, a first communication controller 155, and an image storage 156. These elements are implemented, for example, by the cooperation between software and hardware as the first processor 150A executes the first control program PG1.

The first control program PG1 corresponds to an example of a “display control program”.

The image storage 156 stores, for example, first to M-th moving images V1 to VM corresponding to first to M-th contents C1 to CM, respectively. The integer M is, for example, “9”.

An N-th moving image VN, where N=1 to M, is a moving image obtained by picking up, with a camera, an image of a state where the first projector PJ1 is projecting a projection image PM corresponding to an N-th content CN, onto the projection surface PS. The N-th moving image VN, N=1 to M, is a moving image including the projection image PM projected on the projection surface PS and an image showing the first projector PJ1.

The N-th moving image VN, where N=1 to M, is acquired from the server device 3 by the acquirer 151 and is stored in the image storage 156 by the acquirer 151. In the server device 3, the N-th moving image VN is stored in advance.

In the description below, a case where the integer M is “9” will be described.

The image storage 156 stores the projection image PM projected by the projection controller 153 onto the screen SC. The projection image PM includes a first image P1, a second image P2, and a third image P3.

The projection image PM is generated by combining the first image P1, the second image P2, and the third image P3 by the projection controller 153. The projection image PM is stored in the image storage 156 by the projection controller 153.

In the initial state, the first image P1 is the first moving image V1 corresponding to the first content C1. That is, the first image P1 is the first moving image V1 showing the state where the first projector PJ1 is projecting the first projection image PM1 corresponding to the first content C1, onto the projection surface PS. The first image P1 is, for example, the first moving image V1 obtained by picking up, with a video camera, an image of the state where the first projector PJ1 is projecting the first projection image PM1 corresponding to the first content C1, onto the projection surface PS. For example, the first image P1 may be an animation in which the state where the first projector PJ1 is projecting the projection image PM corresponding to the N-th content CN, where N=1 to 9, onto the projection surface PS, is reproduced by computer graphics or the like.

The first projector PJ1 has the same configuration as that of the projector 1 illustrated in FIG. 1. The projection surface PS is, for example, a surface of a cylindrical column arranged indoors.

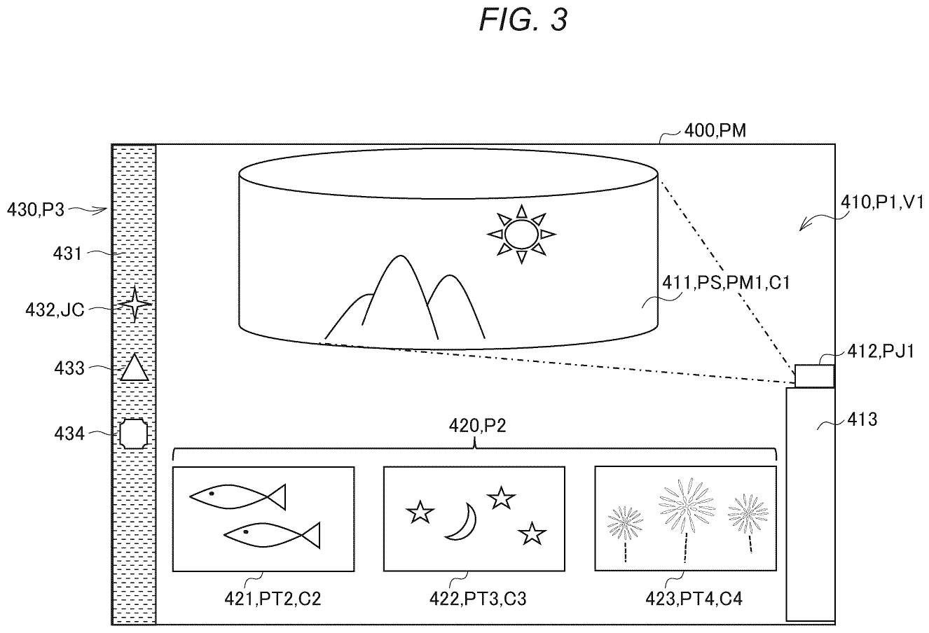

The projection surface PS will be described further with reference to FIGS. 3 to 7.

The second image P2 is a plurality of thumbnail images PT respectively indicating a plurality of contents corresponding to the projection image PM that the projector 1 can project. The plurality of thumbnail images PT include a first thumbnail image PT1 indicating the first content C1.

The projector 1 corresponds to an example of a “second projector”.

In the present embodiment, the plurality of thumbnail images PT are, for example, first to ninth thumbnail images PT1 to PT9 indicating the first to ninth contents C1 to C9, respectively. In other words, an N-th thumbnail image PTN indicates the N-th content CN. The integer N is any one of “1” to “9”. The size of each of the N-th thumbnail images PTN is smaller than the size of the first image P1. The content of each of the N-th thumbnail images PTN may be the same as or different from the content of the first projected image PM1.

The second image P2 is acquired from the server device 3 by the acquirer 151 and is stored in the image storage 156 by the acquirer 151. In the server device 3, the first to ninth thumbnail images PT1 to PT9 are stored in advance.

The third image P3 is an image indicating a menu bar including an icon JC. The icon JC is operated by the user when displaying an image formed by performing processing of reducing the visibility of the first image P1, instead of the first image P1.

The icon JC corresponds to an example of an “object”.

The icon JC and the menu bar will be described further with reference to FIGS. 3 to 7.

The acquirer 151 acquires the first to ninth moving images V1 to V9 from the server device 3. The acquirer 151 stores the first to ninth moving images V1 to V9 in the image storage 156.

The acquirer 151 acquires the first to ninth thumbnail images PT1 to PT9 from the server device 3. The acquirer 151 stores the first to ninth thumbnail images PT1 to PT9 in the image storage 156.

When the image generator 152 accepts an operation on the icon JC from the user, the image generator 152 generates an image formed by performing the processing of reducing the visibility of the first image P1. The processing of reducing the visibility includes at least one of blurring, pixelation, and luminance reduction. In the present embodiment, the processing of reducing the visibility is, for example, “blurring”.

When the first image P1 is the first moving image V1, the image generator 152 generates a first generated image U1 formed by performing the processing of reducing the visibility of the image of each frame forming the first moving image V1 when an operation on the icon JC by the user is accepted. Then, the image generator 152 stores the generated first generated image U1 in the image storage 156. The icon JC functions as a graphical user interface for changing the display mode of the first image P1 or configuring various settings.

When the first image P1 is the N-th moving image VN, where N=2 to 9, the image generator 152 generates an N-th generated image UN formed by performing the processing of reducing the visibility of the image of each frame forming the N-th moving image VN when an operation on the icon JC by the user is accepted. Then, the image generator 152 stores the generated N-th generated image UN in the image storage 156.

In the present embodiment, a case where the image generator 152 generates the N-th generated image UN when an operation on the icon JC by the user is accepted is described, but the embodiment is not limited to this. The N-th generated image UN is a moving image formed by performing the processing of reducing the visibility of the image of each frame forming the N-th moving image VN, where N=1 to 9, corresponding to the first image P1. For example, when the acquirer 151 acquires the N-th moving image VN, where N=1 to 9, from the server device 3, the image generator 152 may generate the N-th generated image UN.

The projection controller 153 causes the projector 1 to project the projection image PM and thus causes the projection image PM to be displayed on the screen SC. The projection image PM includes the first image P1, the second image P2, and the third image P3. The first image P1 is the N-th moving image VN obtained by picking up, with the video camera, an image of the state where the first projector PJ1 is projecting the projection image PM corresponding to the N-th content CN, where N=1 to 9, onto the projection surface PS. The first image P1 may be an animation in which the state where the first projector PJ1 is projecting the projection image PM corresponding to the N-th content CN, where N=1 to 9, onto the projection surface PS, is reproduced by computer graphics or the like. The second image P2 is a plurality of thumbnail images PT respectively indicating a plurality of contents corresponding to the projection image PM that the projector 1 can project. The third image P3 is an image showing the menu bar including the icon JC.

The projection controller 153 combines the first image P1, the second image P2, and the third image P3 together to generate the projection image PM. The projection controller 153 causes the projector 1 to project the generated projection image PM and thus causes the projection image PM to be displayed on the screen SC.

For example, the projection controller 153 combines the first image P1 as a background image with the back side of the second image P2 and the third image P3 and thus generates the projection image PM. The projection controller 153 stores the generated projection image PM in the image storage 156.

The second image P2 is arranged, for example, at a lower part of the image corresponding to the projection surface PS, of the first image P1 in the projection image PM. The third image P3 is arranged, for example, at the left end of the projection image PM.

The projection image PM will be described further with reference to FIGS. 3 to 7.

The acceptor 154 accepts an operation on the icon JC from the user when reducing the visibility of the first image P1 disposed in the projection image PM.

When the acceptor 154 accepts an operation on the icon JC from the user, the image generator 152 generates an image formed by performing the processing of reducing the visibility of the first image P1. Then, the projection controller 153 generates the projection image PM including the image generated by the image generator 152 as the first image P1, causes the projector 1 to project the generated projection image PM, and thus causes the projection image PM to be displayed on the screen SC.

The acceptor 154 also accepts, from the user, an operation on one of the plurality of thumbnail images PT forming the second image P2, when changing the moving image corresponding to the first image P1 disposed in the projection image PM.

When an operation on one of the plurality of thumbnail images PT forming the second image P2 is accepted from the user, the projection controller 153 changes the moving image corresponding to the first image P1 to the N-th moving image VN corresponding to the thumbnail image PT operated by the user.

For example, a case where the plurality of thumbnail images PT forming the second image P2 includes the second thumbnail image PT2 will be described. When an operation, by the user, on the second thumbnail image PT2 of the plurality of thumbnail images PT forming the second image P2 is accepted while the first moving image V1 is displayed as the first image P1, the projection controller 153 executes the following processing. That is, the projection controller 153 changes the moving image corresponding to the first image P1 disposed in the projection image PM from the first moving image V1 to the second moving image V2.

The projection controller 153 uses, for example, the image of each frame of the second moving image V2 as the first image P1, combines the first image P1 as a background image with the back side of the second image P2 and the third image P3, and thus generates the projection image PM. Then, the projection controller 153 causes the projector 1 to project the generated projection image PM and thus causes the projection image PM to be displayed on the screen SC.

The first communication controller 155 receives the first to ninth moving images V1 to V9 from the server device 3 via the first communication interface 141.

The first communication controller 155 also receives the first to ninth thumbnail images PT1 to PT9 from the server device 3 via the first communication interface 141.

Next, the projection image PM will be described further with reference to FIGS. 3 to 6. The projection controller 153 causes the projector 1 to project the projection image PM, and the projection image PM is thus displayed on the screen SC.

FIG. 3 shows a first projection image 400 including the first image P1, the second image P2, and the third image P3. In the initial state, the projection controller 153 causes the projector 1 to project the first projection image 400, and the first projection image 400 is thus displayed on the screen SC.

As illustrated in FIG. 3, the first projection image 400 includes a first image 410, a second image 420, and a third image 430. In the first projection image 400, the first image 410 is displayed as a background image at the back side of the second image 420 and the third image 430.

The first image 410 corresponds to an example of the first image P1.

The second image 420 corresponds to an example of the second image P2.

The third image 430 corresponds to an example of the third image P3.

The first image 410 includes a projection surface image 411, a projector image 412, and a placement table image 413.

The projection surface image 411 is an image showing the projection surface PS. The projection surface PS is, for example, a surface of a cylindrical column arranged indoors. The first projection image PM1 corresponding to the first content C1 is displayed on the projection surface PS. The first projection image PM1 includes, for example, an image of a mountain and an image of the sun.

The projector image 412 is an image showing the first projector PJ1. In the first projection image 400, the first projector PJ1 is projecting the first projection image PM1 corresponding to the first content C1, onto the projection surface PS.

The placement table image 413 is an image showing a placement table where the first projector PJ1 is placed.

The second image 420 includes a thumbnail image 421, a thumbnail image 422, and a thumbnail image 423. In the first projection image 400, the projection controller 153 arranges the second image 420 below the projection surface image 411 in the first image 410. The thumbnail image 421, the thumbnail image 422, and the thumbnail image 423 correspond to the plurality of thumbnail images PT.

The thumbnail image 421 is, for example, the second thumbnail image PT2. The second thumbnail image PT2 is a thumbnail image PT indicating the second content C2.

The thumbnail image 422 is, for example, the third thumbnail image PT3. The third thumbnail image PT3 is a thumbnail image PT indicating the third content C3.

The thumbnail image 423 is, for example, the fourth thumbnail image PT4. The fourth thumbnail image PT4 is a thumbnail image PT indicating the fourth content C4.

The third image 430 includes a menu bar 431, an icon 432, an icon 433, and an icon 434. The projection controller 153 arranges the third image 430 at the left end in the first projection image 400.

The menu bar 431 is displayed in a band-like region extending in the vertical direction in the first projection image 400. The icon 432, the icon 433, and the icon 434 are displayed on the menu bar 431.

The icon 432 corresponds to the icon JC. That is, the icon 432 is operated by the user when displaying an image formed by performing the processing of reducing the visibility of the first image 410, instead of the first image 410.

Each of the icon 433 and the icon 434 accepts an operation different from that of the icon 432.

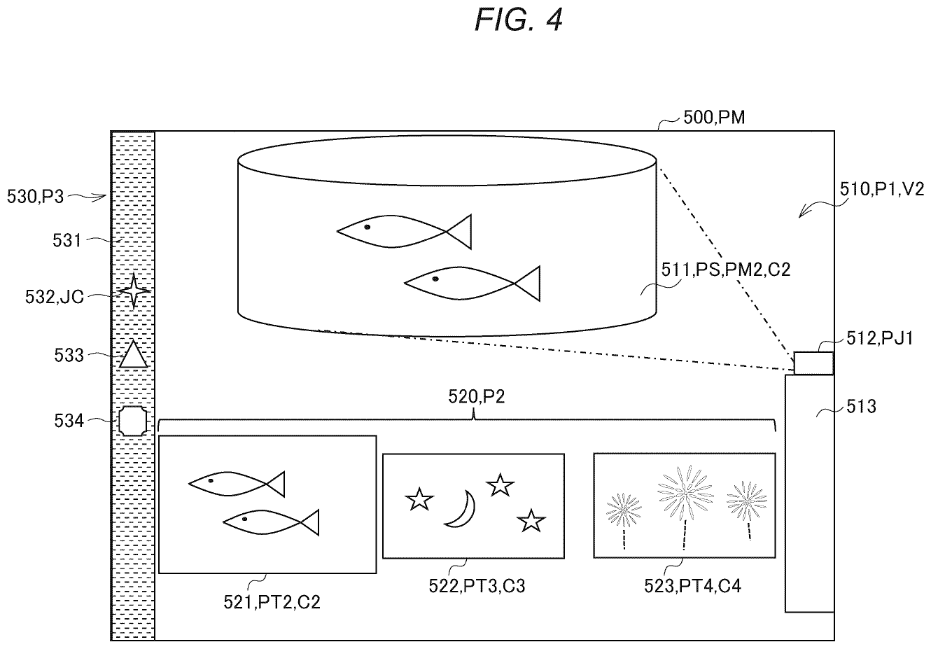

FIG. 4 shows a second projection image 500 including the first image P1, the second image P2, and the third image P3. The second projection image 500 is displayed on the screen SC by the projection controller 153 when the thumbnail image 421 in the first projection image 400 illustrated in FIG. 3 is operated by the user.

As illustrated in FIG. 4, the second projection image 500 includes a first image 510, a second image 520, and a third image 530. In the second projection image 500, the projection controller 153 displays the first image 510 as a background image at the back side of the second image 520 and the third image 530.

The first image 510 corresponds to an example of the first image P1.

The second image 520 corresponds to an example of the second image P2.

The third image 530 corresponds to an example of the third image P3.

The first image 510 includes a projection surface image 511, a projector image 512, and a placement table image 513.

The projection surface image 511 is an image showing the projection surface PS. The projection surface PS is, for example, a surface of a cylindrical column arranged indoors. A second projection image PM2 corresponding to the second content C2 is displayed on the projection surface PS. The second projection image PM2 includes, for example, an image of fish.

The projector image 512 is an image showing the first projector PJ1. In the second projection image 500, the first projector PJ1 is projecting the second projection image PM2 corresponding to the second content C2, onto the projection surface PS.

The placement table image 513 is an image showing a placement table where the first projector PJ1 is placed.

The second image 520 includes a thumbnail image 521, a thumbnail image 522, and a thumbnail image 523. In the second projection image 500, the projection controller 153 arranges the second image 520 below the projection surface image 511 in the first image 510. The thumbnail image 521, the thumbnail image 522, and the thumbnail image 523 correspond to the plurality of thumbnail images PT.

The thumbnail image 521 is, for example, the second thumbnail image PT2. The second thumbnail image PT2 is a thumbnail image PT indicating the second content C2.

The thumbnail image 522 is, for example, the third thumbnail image PT3. The third thumbnail image PT3 is a thumbnail image PT indicating the third content C3.

The thumbnail image 523 is, for example, the fourth thumbnail image PT4. The fourth thumbnail image PT4 is a thumbnail image PT indicating the fourth content C4.

In the second projection image 500, the projection controller 153 displays the thumbnail image 521 in a larger size than the thumbnail image 522 and the thumbnail image 523. With this display, the user knows that the second content C2 corresponding to the thumbnail image 521 is projected on the projection surface PS.

The third image 530 includes a menu bar 531, an icon 532, an icon 533, and an icon 534. The projection controller 153 arranges the third image 530 at the left end in the second projection image 500.

The menu bar 531 is displayed in a band-like region extending in the vertical direction in the second projection image 500. The icon 532, the icon 533, and the icon 534 are displayed on the menu bar 531.

The icon 532 corresponds to the icon JC. That is, the icon 532 is operated by the user when displaying an image formed by performing the processing of reducing the visibility of the first image 510, instead of the first image 510.

Each of the icon 533 and the icon 534 accepts an operation different from that of the icon 532.

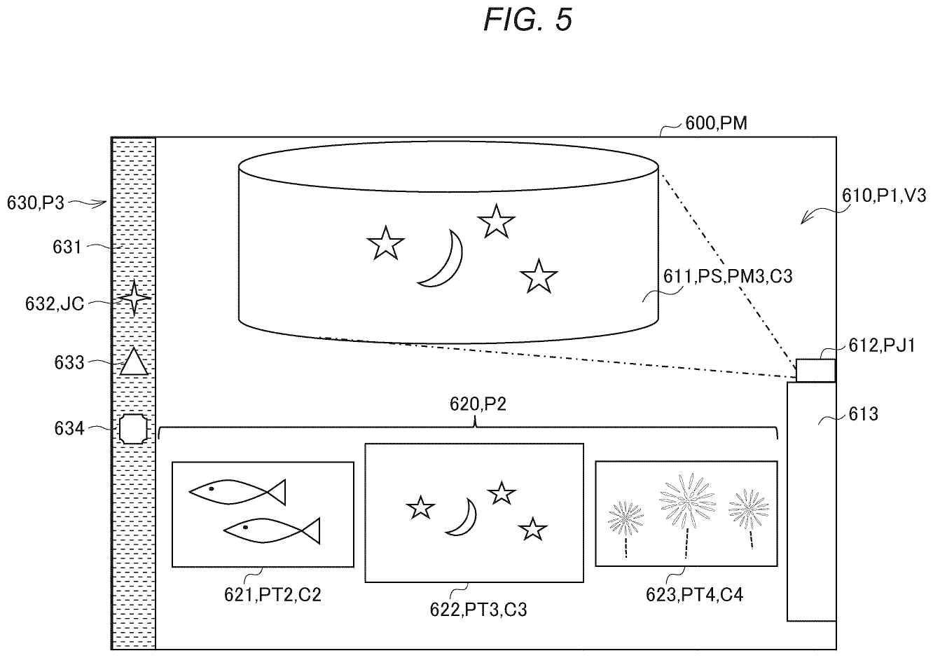

FIG. 5 shows a third projection image 600 including the first image P1, the second image P2, and the third image P3. The third projection image 600 is displayed on the screen SC by the projection controller 153 when the thumbnail image 422 in the first projection image 400 illustrated in FIG. 3 is operated by the user.

As illustrated in FIG. 5, the third projection image 600 includes a first image 610, a second image 620, and a third image 630. In the third projection image 600, the projection controller 153 displays the first image 610 as a background image at the back side of the second image 620 and the third image 630.

The first image 610 corresponds to an example of the first image P1.

The second image 620 corresponds to an example of the second image P2.

The third image 630 corresponds to an example of the third image P3.

The first image 610 includes a projection surface image 611, a projector image 612, and a placement table image 613.

The projection surface image 611 is an image showing the projection surface PS. The projection surface PS is, for example, a surface of a cylindrical column arranged indoors. A third projection image PM3 corresponding to the third content C3 is displayed on the projection surface PS. The third projection image PM3 includes, for example, an image of the moon and an image of a star.

The projector image 612 is an image indicating the first projector PJ1. In the third projection image 600, the first projector PJ1 is projecting the third projection image PM3 corresponding to the third content C3, onto the projection surface PS.

The placement table image 613 is an image showing a placement table where the first projector PJ1 is placed.

The second image 620 includes a thumbnail image 621, a thumbnail image 622, and a thumbnail image 623. In the third projection image 600, the projection controller 153 arranges the second image 620 below the projection surface image 611 in the first image 610. The thumbnail image 621, the thumbnail image 622, and the thumbnail image 623 correspond to the plurality of thumbnail images PT.

The thumbnail image 621 is, for example, the second thumbnail image PT2. The second thumbnail image PT2 is a thumbnail image PT indicating the second content C2.

The thumbnail image 622 is, for example, the third thumbnail image PT3. The third thumbnail image PT3 is a thumbnail image PT indicating the third content C3.

The thumbnail image 623 is, for example, the fourth thumbnail image PT4. The fourth thumbnail image PT4 is a thumbnail image PT indicating the fourth content C4.

In the third projection image 600, the projection controller 153 displays the thumbnail image 622 in a larger size than the thumbnail image 621 and the thumbnail image 623. With this display, the user knows that the third content C3 corresponding to the thumbnail image 622 is projected on the projection surface PS.

The third image 630 includes a menu bar 631, an icon 632, an icon 633, and an icon 634. The projection controller 153 arranges the third image 630 at the left end in the third projection image 600.

The menu bar 631 is displayed in a band-like region extending in the vertical direction in the third projection image 600. The icon 632, the icon 633, and the icon 634 are displayed on the menu bar 631.

The icon 632 corresponds to the icon JC. That is, the icon 632 is operated by the user when displaying an image formed by performing the processing of reducing the visibility of the first image 610, instead of the first image 610.

Each of the icon 633 and the icon 634 accepts an operation different from that of the icon 632.

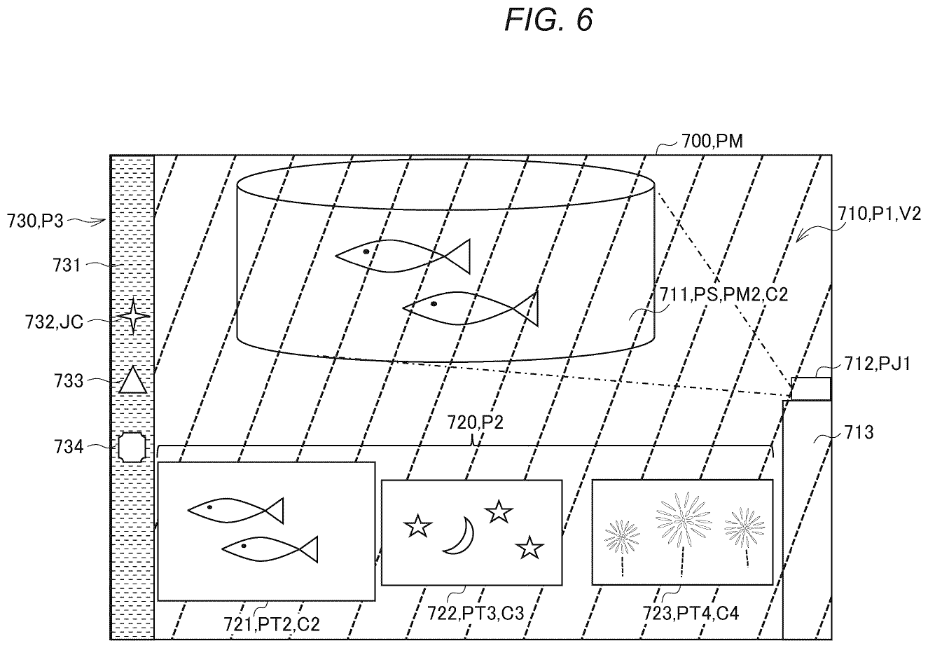

FIG. 6 shows a fourth projection image 700 including the first image P1, the second image P2, and the third image P3. The fourth projection image 700 is displayed on the screen SC by the projection controller 153 when the icon 532 in the second projection image 500 illustrated in FIG. 4 is operated by the user.

As illustrated in FIG. 6, the fourth projection image 700 includes a first image 710, a second image 720, and a third image 730. In the fourth projection image 700, the projection controller 153 displays the first image 710 as a background image at the back side of the second image 720 and the third image 730.

The first image 710 corresponds to an example of the first image P1.

The second image 720 corresponds to an example of the second image P2.

The third image 730 corresponds to an example of the third image P3.

When the icon 532 in the second projection image 500 illustrated in FIG. 4 is operated by the user, the image generator 152 generates the first image 710 formed by performing the processing of reducing the visibility of the first image 510 illustrated in FIG. 4. The projection controller 153 generates the projection image PM including the first image 710 generated by the image generator 152. Then, the projection controller 153 causes the projector 1 to project the generated projection image PM and thus causes the projection image PM to be displayed on the screen SC.

As illustrated in FIG. 6, the first image 710 is shaded, which indicates that the first image 710 is an image formed by performing the processing of reducing the visibility by the image generator 152.

The first image 710 includes a projection surface image 711, a projector image 712, and a placement table image 713.

The projection surface image 711 is an image showing the projection surface PS. The projection surface PS is, for example, a surface of a cylindrical column arranged indoors. The second projection image PM2 corresponding to the second content C2 is displayed on the projection surface PS. The second projection image PM2 includes, for example, an image of fish.

The projector image 712 is an image indicating the first projector PJ1. In the fourth projection image 700, the first projector PJ1 is projecting the second projection image PM2 corresponding to the second content C2, onto the projection surface PS.

The placement table image 713 is an image showing a placement table where the first projector PJ1 is placed.

The second image 720 includes a thumbnail image 721, a thumbnail image 722, and a thumbnail image 723. In the fourth projection image 700, the projection controller 153 arranges the second image 720 below the projection surface image 711 in the first image 710. The thumbnail image 721, the thumbnail image 722, and the thumbnail image 723 correspond to the plurality of thumbnail images PT.

The thumbnail image 721 is, for example, the second thumbnail image PT2. The second thumbnail image PT2 is a thumbnail image PT indicating the second content C2.

The thumbnail image 722 is, for example, a third thumbnail image PT3. The third thumbnail image PT3 is a thumbnail image PT indicating the third content C3.

The thumbnail image 723 is, for example, the fourth thumbnail image PT4. The fourth thumbnail image PT4 is a thumbnail image PT indicating the fourth content C4.

In the fourth projection image 700, the projection controller 153 displays the thumbnail image 721 in a larger size than the thumbnail image 722 and the thumbnail image 723. With this display, the user knows that the second content C2 corresponding to the thumbnail image 721 is projected on the projection surface PS.

The third image 730 includes a menu bar 731, an icon 732, an icon 733, and an icon 734. The projection controller 153 arranges the third image 730 at the left end in the fourth projection image 700.

The menu bar 731 is displayed in a band-like region extending in the vertical direction in the fourth projection image 700. The icon 732, the icon 733, and the icon 734 are displayed on the menu bar 731.

The icon 732 corresponds to the icon JC.

Each of the icon 733 and the icon 734 accepts an operation different from that of the icon 732.

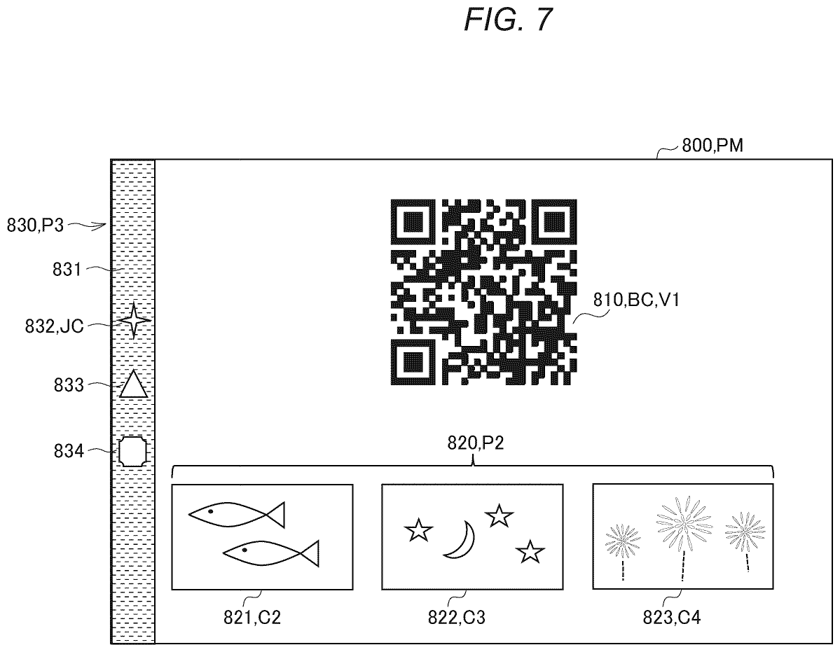

FIG. 7 shows a fifth projection image 800 including the first image P1, the second image P2, and the third image P3. In the initial state, the projection controller 153 causes the projector 1 to project the fifth projection image 800, and the fifth projection image 800 is thus displayed on the screen SC.

As illustrated in FIG. 7, the fifth projection image 800 includes a first image 810, a second image 820, and a third image 830.

The first image 810 corresponds to an example of the first image P1.

The second image 820 corresponds to an example of the second image P2.

The third image 830 corresponds to an example of the third image P3.

The first image 810 includes a two-dimensional barcode BC.

The two-dimensional barcode BC indicates the uniform resource locator (URL) of the server device 3 distributing the first moving image V1 including the first projection image PM1 projected on the projection surface PS and the image indicating the first projector PJ1.

The two-dimensional barcode BC is read, for example, by a smartphone, not illustrated. Then, the first moving image V1 is acquired from the server device 3 by the smartphone. Also, the first moving image V1 is displayed by the smartphone.

In this case, the acquirer 151 does not need to execute the processing of acquiring the first to ninth moving images V1 to V9. The projection controller 153 does not need to project the N-th moving image VN, where N=1 to 9. Thus, the processing of the first controller 150 can be simplified.

The second image 820 includes a thumbnail image 821, a thumbnail image 822, and a thumbnail image 823. In the fifth projection image 800, the projection controller 153 arranges the second image 820 below the first image 810. The thumbnail image 821, the thumbnail image 822, and the thumbnail image 823 correspond to the plurality of thumbnail images PT.

The thumbnail image 821 is, for example, the second thumbnail image PT2. The second thumbnail image PT2 is a thumbnail image PT indicating the second content C2.

The thumbnail image 822 is, for example, the third thumbnail image PT3. The third thumbnail image PT3 is a thumbnail image PT indicating the third content C3.

The thumbnail image 823 is, for example, the fourth thumbnail image PT4. The fourth thumbnail image PT4 is a thumbnail image PT indicating the fourth content C4.

The third image 830 includes a menu bar 831, an icon 832, an icon 833, and an icon 834. The projection controller 153 arranges the third image 830 at the left end in the fifth projection image 800.

The menu bar 831 is displayed in a band-like region extending in the vertical direction in the fifth projection image 800. The icon 832, the icon 833, and the icon 834 are displayed on the menu bar 831.

The icon 832 corresponds to the icon JC.

Each of the icon 833 and the icon 834 accepts an operation different from that of the icon 832.

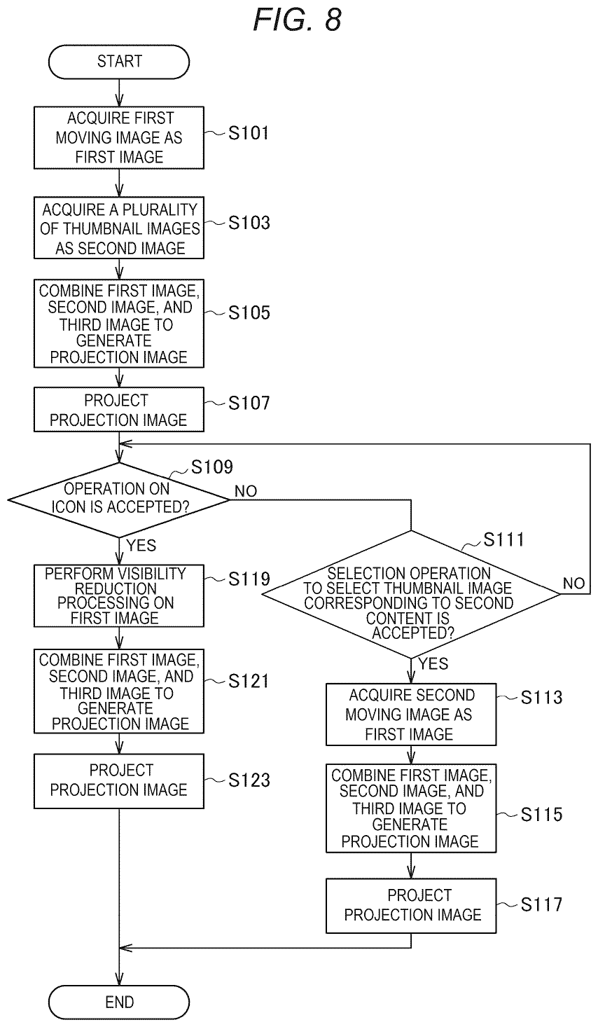

Next, the processing of the first controller 150 will be described with reference to FIG. 8. FIG. 8 is a flowchart illustrating an example of the processing of the first controller 150.

As illustrated in FIG. 8, first, in step S101, the acquirer 151 acquires the first moving image V1 as the first image P1 from the server device 3.

Next, in step S103, the acquirer 151 acquires a plurality of thumbnail images PT as the second image P2. The acquirer 151 acquires, for example, the first to ninth thumbnail images PT1 to PT9 as the second image P2.

Next, in step S105, the projection controller 153 combines the first image P1, the second image P2, and the third image P3 together to generate the projection image PM. The projection controller 153 combines, for example, the first image P1 as a background image with the back side of the second image P2 and the third image P3 and thus generates the projection image PM. The third image P3 is an image showing a menu bar including the icon JC.

Next, in step S107, the projection controller 153 causes the projector 1 to project the projection image PM generated in step S105 and thus causes the projection image PM to be displayed on the screen SC.

Next, in step S109, the acceptor 154 determines whether an operation on the icon JC is accepted from the user.

When the acceptor 154 determines that an operation on the icon JC by the user is accepted (YES in step S109), the processing proceeds to step S119. When the acceptor 154 determines that an operation on the icon JC by the user is not accepted (NO in step S109), the processing proceeds to step S111.

In step S111, the acceptor 154 determines whether an operation on the second thumbnail image PT2 by the user is accepted. The second thumbnail image PT2 is a thumbnail image PT indicating the second content C2. The second thumbnail image PT2 is included in the plurality of thumbnail images PT forming the second image P2.

When the acceptor 154 determines that an operation on the second thumbnail image PT2 by the user is not accepted (NO in step S111), the processing returns to step S109. When the acceptor 154 determines that an operation on the second thumbnail image PT2 by the user is accepted (YES in step S111), the processing proceeds to Step S113.

In step S113, the acquirer 151 acquires the second moving image V2 as the first image P1 from the server device 3.

Next, in step S115, the projection controller 153 combines the first image P1, the second image P2, and the third image P3 together to generate the projection image PM.

Next, in step S117, the projection controller 153 causes the projector 1 to project the projection image PM generated in step S115 and thus causes the projection image PM to be displayed on the screen SC. Subsequently, the processing ends.

When YES in step S109, the image generator 152 generates an image formed by performing the processing of reducing the visibility of the first image P1, in step S119. For example, the image generator 152 generates the first generated image U1 formed by performing the processing of reducing visibility of the image of each frame forming the first moving image V1.

Next, in step S121, the projection controller 153 combines the first image P1, the second image P2, and the third image P3 together to generate the projection image PM. The first image P1 is the first generated image U1 generated in step S121.

Next, in step S123, the projection controller 153 causes the projector 1 to project the projection image PM generated in step S121 and thus causes the projection image PM to be displayed on the screen SC. Subsequently, the processing ends.

### Present Embodiment and Advantageous Effects

As described above with reference to the drawings, the display control method according to the present embodiment includes causing the projector 1 to display the first image P1 showing the state where the first projector PJ1 is projecting the first projection image PM1 corresponding to the first content C1, onto the projection surface PS, and the second image P2, which is the plurality of thumbnail images PTN, where N=1 to M, respectively indicating the plurality of contents CN, where N=1 to M, corresponding to the projection image PM that the second projector PJ2 can project.

That is, the projector 1 displays the first image P1 and the second image P2. The first image P1 shows the state where the first projector PJ1 is projecting the first projection image PM1 corresponding to the first content C1, onto the projection surface PS. The second image P2 is the plurality of thumbnail images PTN, where N=1 to M, respectively indicating the plurality of contents CN, where N=1 to M, corresponding to the projection image PM that the second projector PJ2 can project.

Thus, by referring to the first image P1, for example, the user can more easily grasp or imagine that the projection image PM corresponding to each of the plurality of contents CN, where N=1 to M, can be projected onto the projection surface such as the projection surface PS by the second projector PJ2. Thus, the user can easily understand the method of utilizing the plurality of contents CN.

Also, by referring to the first image P1, for example, the user can learn that the projection image PM corresponding to each of the plurality of contents CN, where N=1 to M, can be projected onto the projection surface such as the projection surface PS by the second projector PJ2. Thus, the user can learn a technique relating to the method of using the projector PJ.

Also, in the display control method, the first image P1 is a moving image including the first projection image PM1 projected on the projection surface PS and the image indicating the first projector PJ1, and the first image P1 is displayed as a background image at the back side of the second image P2 by the projector 1.

Since the first image P1 is a moving image including the first projection image PM1 projected on the projection surface PS and the image indicating the first projector PJ1, the user can check the positional relationship between the projection surface PS and the first projector PJ1. Thus, by referring to the first image P1, for example, the user can learn that the projection image PM corresponding to each of the plurality of contents CN, where N=1 to M, can be projected onto the projection surface such as the projection surface PS by the second projector PJ2.

Also, since the first image P1 is displayed as a background image at the back side of the second image P2 by the projector 1, a situation where the second image P2 is less visible due to the first image P1 can be suppressed.

Also, in the display control method, the plurality of thumbnail images PTN, where N=1 to M, include the first thumbnail image PT1 indicating the first content C1.

Therefore, the user can check the first content C1 corresponding to the first projection image PM1 projected on the projection surface PS, in the first image P1. Thus, the user can deeply understand the state where the first projection image PM1 corresponding to the first content C1 is projected on the projection surface PS, in the first image P1.

Also, the display control method includes: accepting an operation of selecting one thumbnail image from among the plurality of thumbnail images PTN, where N=1 to M; and causing the projector 1 to display an image showing a state where the first projector PJ1 is projecting the second projection image PM2 corresponding to the second content C2, onto the projection surface PS, when the second thumbnail image PT2 corresponding to the second content C2 different from the first content C1 is selected.

Therefore, by referring to the image, the user can check the state where the first projector PJ1 is projecting the second projection image PM2 corresponding to the second content C2, onto the projection surface PS. Thus, for example, the user can learn that the projection image PM corresponding to each of the plurality of contents CN, where N=1 to M, can be projected onto the projection surface such as the projection surface PS by the second projector PJ2.

Also, the display control method includes: causing the projector 1 to display the icon JC; causing the projector 1 to display an image formed by performing the processing of reducing the visibility of the first image P1 when an operation on the icon JC by the user is accepted; and accepting an operation of selecting one thumbnail image from among the plurality of thumbnail images PTN, where N=1 to M.

Since the image formed by performing the processing of reducing the visibility of the first image P1 is displayed instead of the first image P1, the user can more easily take notice of the plurality of thumbnail images PTN, where N=1 to M. Thus, the operation by the user of selecting one thumbnail image from among the plurality of thumbnail images PTN, where N=1 to M, can be made easier.

Also, in the display control method, the processing of reducing the visibility includes at least one of blurring, pixelation, and luminance reduction.

Thus, an image formed by performing the processing of reducing the visibility of the first image P1 can be easily generated.

Also, in the display control method, the first image P1 is the two-dimensional barcode BC indicating the URL of the server device 3 distributing the first moving image V1 including the first projection image PM1 projected on the projection surface PS and the image indicating the first projector PJ1, and for example, a smartphone is made to display the first moving image V1 acquired from the server device 3, based on the URL.

Since, for example, the smartphone displays the first moving image V1 acquired from the server device 3, based on the URL indicated by the two-dimensional barcode BC, the processing of the projector 1 can be simplified.

The projector 1 according to the present embodiment displays the first image P1 showing a state where the first projector PJ1 is projecting the first projection image PM1 corresponding to the first content C1, onto the projection surface PS, and the second image P2, which is the plurality of thumbnail images PTN, where N=1 to M, respectively indicating the plurality of contents CN, where N=1 to M, corresponding to the projection image PM which the second projector PJ2 can project.

Thus, the projector 1 according to the present embodiment can achieve effects similar to those of the display control method according to the present embodiment.

The first control program PG1 according to the present embodiment causes the first processor 150A controlling the projector 1, to execute causing the projector 1 to display the first image P1 showing a state where the first projector PJ1 is projecting the first projection image PM1 corresponding to the first content C1, onto the projection surface PS, and the second image P2, which is the plurality of thumbnail images PTN, N=1 to M, respectively indicating the plurality of contents CN, where N=1 to M, corresponding to the projection image PM that the second projector PJ2 can project.

Thus, the first control program PG1 according to the present embodiment can achieve effects similar to those of the display control method according to the present embodiment.

### Other Embodiments

The above-described present embodiment is a preferred embodiment. However, the present disclosure is not limited to the above-described embodiment, and various modifications can be made without departing from the spirit and scope of the present disclosure.

In the present embodiment, a case where the “display device” is the projector 1 is described, but the embodiment is not limited to this. The “display device” may be, for example, a personal computer coupled to a display. Also, the “display device” may be, for example, a tablet device or a smartphone.

In the present embodiment, a case where the “second projector” is the projector 1 is described, but the embodiment is not limited to this. The “second projector” may be the same projector as the “first projector” or may be a different projector from the “first projector”.

In the present embodiment, a case where the projection surface PS is a surface of a cylindrical column arranged indoors is described, but the embodiment is not limited to this. The projection surface PS may be a surface of an object different from the screen SC. The projection surface PS may be, for example, a wall surface of a room. Also, the projection surface PS may be, for example, a wall surface of a classroom, a lecture hall, or a gymnasium. The projection surface PS may be, for example, a wall surface of a building, as in projection mapping.

In the present embodiment, a case where the “object” is the icon JC is described, but the embodiment is not limited to this. The “object” may be, for example, a button object. The “object” may be, for example, an image.

In the present embodiment, a case where the first image P1 includes the first projection image PM1 projected on the projection surface PS and the image indicating the first projector PJ1 is described, but the embodiment is not limited to this. The first image P1 may be an image obtained by picking up an image of a state where the first projector PJ1 is projecting the first projection image PM1 corresponding to the first content C1, onto the projection surface PS. For example, the first image P1 may not include an image indicating the first projector PJ1. In this case, an image or the like indicating the position of the first projector PJ1 in relation to the projection surface PS may be displayed.

The functional units shown in FIG. 2 represent the functional configuration, and the specific implementation forms thereof are not particularly limited. That is, hardware individually corresponding to the functional units does not necessarily need to be implemented, and a configuration in which one processor executes a program to implement functions of a plurality of functional units may be employed. Also, a part of the functions implemented by software in the embodiment may be implemented by hardware, or a part of the functions implemented by hardware may be implemented by software. In addition, any changes can be made to the specific detailed configuration of each part of the projector 1 without departing from the scope of the present disclosure.

The processing steps in the flowchart shown in FIG. 8 are provided by dividing the processing according to the main content of the processing in order to facilitate the understanding of the processing of the first controller 150 of the projector 1. The way the processing is divided into processing steps and the names of the processing steps shown in the flowchart of FIG. 8 do not limit the present disclosure, and the processing may also be divided into more steps according to the content of the processing and the processing may also be divided in such a way that one processing step includes more processing. Also, the order of the processing in the foregoing flowchart is not limited to the illustrated example.

The “display control method” can be realized by causing the first processor 150A provided in the projector 1 to execute the first control program PG1 corresponding to the display control method. The first control program PG1 can also be computer-readably recorded in a recording medium.

As the recording medium, a magnetic or optical recording medium or a semiconductor memory device can be used. Specifically, a portable or stationary recording medium may be employed, such as a flexible disc, an HDD, a compact disk read-only memory (CD-ROM), a DVD, a Blu-ray (trademark registered) disc, a magneto-optical disc, a flash memory, and a card-type recording medium. The recording medium may also be a nonvolatile storage device such as a RAM, a ROM, or an HDD, which is an internal storage device provided in the projector 1.

The display control method can also be realized by storing the first control program PG1 in a server device or the like and downloading the first control program PG1 from the server device to the projector 1.

### APPENDICES

The present disclosure will be summarized below in the form of appendices.

(Appendix 1) A display control method includes causing a display device to display a first image showing a state where a first projector is projecting a first projection image corresponding to a first content, onto a projection surface, and a second image that is a plurality of thumbnail images respectively indicating a plurality of contents corresponding to a projection image that a second projector can project.

Thus, the display device displays the first image and the second image. The first image is an image obtained by picking up an image of the state where the first projector is projecting the first projection image corresponding to the first content, onto the projection surface. The second image is the plurality of thumbnail images respectively indicating the plurality of contents corresponding to the projection image that the second projector can project.

Thus, by referring to the first image, for example, the user can grasp or imagine the method of utilizing the projection image corresponding to each of the plurality of contents by the second projector.

(Appendix 2) In the display control method according to Appendix 1, the first image is a moving image including the first projection image projected on the projection surface and an image indicating the first projector, and the first image is displayed as a background image at a back side of the second image by the display device.

Therefore, the user can check the positional relationship between the projection surface and the first projector. Thus, by referring to the first image, for example, the user can learn that the projection image corresponding to each of the plurality of contents can be projected onto the projection surface by the second projector. Also, since the first image is displayed as a background image at the back side of the second image by the display device, a situation where the second image is less visible due to the first image can be suppressed.

(Appendix 3) In the display control method according to Appendix 2, the plurality of thumbnail images include a first thumbnail image indicating the first content.

Therefore, the user can check the first content corresponding to the projection image projected on the projection surface, in the first image. Thus, based on the first image, the user can deeply understand the state where the first projection image corresponding to the first content is projected on the projection surface.

(Appendix 4) The display control method according to any one of Appendices 1 to 3 also includes: accepting an operation of selecting one thumbnail image from among the plurality of thumbnail images; and when the thumbnail image corresponding to the second content different from the first content is selected, causing the display device to display an image showing a state where the first projector projects the second projection image corresponding to the second content, onto the projection surface.

Therefore, by referring to the image showing the state where the first projector projects the second projection image corresponding to the second content, the user can check the state where the first projector is projecting the second projection image corresponding to the second content, onto the projection surface. Thus, for example, the user can learn that the projection image corresponding to each of the plurality of contents can be projected onto the projection surface by the second projector.

(Appendix 5) The display control method according to any one of Appendices 1 to 4 includes: causing the display device to display an object; causing the display device to display an image formed by performing processing of reducing a visibility of the first image when an operation on the object by the user is accepted; and accepting an operation of selecting one thumbnail image from among the plurality of thumbnail images.

Since the image formed by performing the processing of reducing the visibility of the first image is displayed instead of the first image, the user can more easily take notice of the plurality of thumbnail images. Thus, the operation by the user of selecting one thumbnail image from among the plurality of thumbnail images can be made easier.

(Appendix 6) In the display control method according to Appendix 5, the processing of reducing the visibility includes at least one of blurring, pixelation, and luminance reduction.

Thus, an image formed by performing the processing of reducing the visibility of the first image can be easily generated.

(Appendix 7) In the display control method according to anyone of Appendices 1 to 6, the first image is a two-dimensional barcode indicating a URL of a server device distributing a moving image including the first projection image projected on the projection surface and an image indicating the first projector, and a second display device that is different from the display device is made to display the moving image acquired from the server device, based on the URL.

Since, for example, a smartphone displays the first moving image acquired from the server device, based on the URL indicated by the two-dimensional barcode, the processing of the display device can be simplified.

(Appendix 8) A display device displays a first image showing a state where a first projector is projecting a first projection image corresponding to a first content, onto a projection surface, and a second image that is a plurality of thumbnail images respectively indicating a plurality of contents corresponding to a projection image that a second projector can project.

The display device according to Appendix 8 has effects similar to those of the display control method according to Appendix 1.

(Appendix 9) A non-transitory computer-readable storage medium storing a display control program is provided, the display control program causing a computer controlling a display device, to execute causing the display device to display a first image showing a state where a first projector is projecting a first projection image corresponding to a first content, onto a projection surface, and a second image that is a plurality of thumbnail images respectively indicating a plurality of contents corresponding to a projection image that a second projector can project.

The display control program according to Appendix 9 has effects similar to those of the display control method according to Appendix 1.

What is claimed is:

1. A display control method comprising:
causing a display device to display
a first image showing a state where a first projector is projecting a first projection image corresponding to a first content, onto a projection surface; and
a second image that is a plurality of thumbnail images respectively indicating a plurality of contents corresponding to a projection image that a second projector can project.

2. The display control method according to claim 1, wherein
the first image is a moving image including the first projection image projected on the projection surface and an image indicating the first projector, and
the first image is displayed as a background image at a back side of the second image by the display device.

3. The display control method according to claim 2, wherein
the plurality of thumbnail images include a first thumbnail image indicating the first content.

4. The display control method according to claim 1, further comprising:
accepting an operation of selecting one thumbnail image from among the plurality of thumbnail images; and
when a thumbnail image corresponding to a second content different from the first content is selected, causing the display device to display an image showing a state where the first projector projects a second projection image corresponding to the second content, onto the projection surface.

5. The display control method according to claim 1, further comprising:
causing the display device to display an object;
causing the display device to display an image formed by performing processing of reducing a visibility of the first image when an operation on the object by a user is accepted; and
accepting an operation of selecting one thumbnail image from among the plurality of thumbnail images.

6. The display control method according to claim 5, wherein
the processing of reducing the visibility includes at least one of blurring, pixelation, and luminance reduction.

7. The display control method according to claim 1, wherein
the first image is a two-dimensional barcode indicating a URL of a server device distributing a moving image including the first projection image projected on the projection surface and an image indicating the first projector, and
a second display device that is different from the display device is made to display the moving image acquired from the server device, based on the URL.

8. A display device displaying:
a first image showing a state where a first projector is projecting a first projection image corresponding to a first content, onto a projection surface; and
a second image that is a plurality of thumbnail images respectively indicating a plurality of contents corresponding to a projection image that a second projector can project.

9. A non-transitory computer-readable storage medium storing a display control program, the display control program causing a computer controlling a display device,
to execute causing the display device to display
a first image showing a state where a first projector is projecting a first projection image corresponding to a first content, onto a projection surface, and
a second image that is a plurality of thumbnail images respectively indicating a plurality of contents corresponding to a projection image that a second projector can project.
